(19) United States
(12) Patent Application Publication
(10) Pub. No.: US 2012/0089743 A1
(43) Pub. Date: Apr. 12, 2012

(54) METHOD AND APPARATUS FOR IMPROVING QUALITY OF SERVICE IN A MULTIMEDIA STREAMING SERVICE

(75) Inventors: Kyung-Mo PARK, Seoul (KR); Jae-Yeon Song, Seoul (KR)

(73) Assignee: Samsung Electronics Co., Ltd., Suwon-si (KR)

(21) Appl. No.: 13/270,534

(22) Filed: Oct. 11, 2011

(30) Foreign Application Priority Data
Oct. 8, 2010 (KR) 10-2010-0098523

(51) Int. Cl. H04L 29/06

(52) U.S. Cl. 709/231

(57) ABSTRACT

A method and apparatus for improving Quality of Service (QoS) in a multimedia streaming service are provided, in which at least one of a plurality of multimedia streams is configured to include reference information about at least one frame included in at least one of the other multimedia streams, and the configured multimedia stream is transmitted.

### PRIORITY

This application claims priority under 35 U.S.C. §119(a) to Korean Patent Application Serial No. 10-2010-0098523, which was filed in the Korean Intellectual Property Office on Oct. 8, 2010, the entire content of which is incorporated herein by reference.

### BACKGROUND OF THE INVENTION

1. Field of the Invention

The present invention relates generally to a method and apparatus for providing a multimedia service, and more particularly, to a method and apparatus for guaranteeing Quality of Service (QoS) in a multimedia streaming service using Hypertext Transfer Protocol (HTTP) and Transmission Control Protocol (TCP).

2. Description of the Related Art

With the explosive growth of portable device use, multimedia streaming services have also grown in popularity.

FIG. 1 illustrates a conventional Trick-play and Random Access (TRA) operation in a multimedia streaming service. Herein, the term “Representation” refers to a structured collection of one or more media components.

Referring to FIG. 1, hatched blocks represent Random Access Points (RAPs), e.g., where pictures can be independently decoded. That is, RAPs are Independently Decoded Refresh (IDR) frames. To have the same TRA performance in each Representation, the number of RAPs for the same period should be the same in each Representation. However, as the number of RAPs increases, a Representation with a higher quality suffers from a larger load. Table 1 below lists an average number of bits per frame for each frame type.

TABLE 1

| Sequence | | Foreman | |
|---|---|---|---|
| Size | | CIF | |
| Bitrate | | 375 | kbps |
| PSNR | | 35 | dB |
| Average | I-Frame | 71,688 | bits |
| Bits per a | P-Frame | 18,797 | bits |
| Frame | B-Frame | 7629 | bits |

Referring to Table 1, using a Foreman sequence, an Intra frame is 9 times larger than a B-Frame in bit size. Therefore, shortening a RAP period or an I-Frame period for minimizing TRA-incurred degradation of QoS and Quality of Experience (QoE) increases content size, thereby increasing a load on the part of a server. Although it may differ in different TRA modes, the number of I-Frames that a client should receive for the same time period increases due to TRA. Because the client has a limited available bandwidth, the client should receive more I-Frames.

Accordingly, a need exists for a method of reducing transmission delay and resource utilization inefficiency that is often involved in the current multimedia streaming services.

### SUMMARY OF THE INVENTION

The present invention is designed to address at least the problems and/or disadvantages above and to provide at least the advantages described below.

Accordingly, an aspect of the present invention is to provide a method and apparatus for minimizing QoS degradation in a multimedia streaming service.

Another aspect of the present invention is to provide a method and apparatus for minimizing QoS degradation and QoE degradation caused by TRA in a multimedia streaming service.

In accordance with an aspect of the present invention, a method is provided for providing a multimedia streaming service using a plurality of multimedia streams, in which at least one of the plurality of multimedia streams includes reference information about at least one frame included in at least one of the other multimedia streams.

In accordance with another aspect of the present invention, a method is provided for receiving a multimedia streaming service using a plurality of multimedia streams, in which a multimedia stream is received and reproduced. The received multimedia stream includes reference information about at least one frame included in at least one of the other multimedia streams.

In accordance with another aspect of the present invention, an apparatus for providing a multimedia streaming service using a plurality of multimedia streams is provided, in which a controller configures at least one of the plurality of multimedia streams to include reference information about at least one frame included in at least one of the other multimedia streams, and a transmitter transmits the configured multimedia stream.

In accordance with a further aspect of the present invention, an apparatus for receiving a multimedia streaming service using a plurality of multimedia streams is provided, in which a receiver receives a multimedia stream, and a controller reproduces the multimedia stream. The received multimedia stream includes reference information about at least one frame included in at least one of the other multimedia streams.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates a conventional TRA operation in a multimedia streaming service;

FIG. 2 illustrates a TRA operation according to an embodiment of the present invention;

FIG. 3 illustrates a Representation including an index of reference to another Representation according to an embodiment of the present invention;

FIG. 4 illustrates extended segment indexes (sidxs) for cross referencing according to an embodiment of the present invention;

FIG. 5 is a block diagram illustrating an apparatus for providing a multimedia streaming service according to an embodiment of the present invention; and

FIG. 6 is a block diagram illustrating an apparatus for receiving a multimedia streaming service according to an embodiment of the present invention.

Throughout the drawings, the same drawing reference numerals will be understood to refer to the same elements, features and structures.

### DETAILED DESCRIPTION OF EMBODIMENTS OF THE INVENTION

Various embodiments of the present invention will be described in detail with reference to the accompanying drawings. In the following description, specific details such as detailed configuration and components are merely provided to assist the overall understanding of various embodiments of the present invention. Therefore, it should be apparent to those of ordinary skill in the art that various changes and modifications of the embodiments described herein can be made without departing from the scope and spirit of the invention. In addition, descriptions of well-known functions and constructions are omitted for clarity and conciseness.

A method in accordance with an embodiment of the present invention selectively configures a part of existing Representations to have features suitable for TRA in a multimedia streaming service. For example, when there are multiple Representations, a few Representations selected from these multiple Representations may take features suitable for TRA. For instance, a Representation with low video quality and a Representation with high video quality may exist. The multimedia streaming service includes, for example, a multimedia service using Hypertext Transfer Protocol (HTTP)/Transmission Control Protocol (TCP).

<Representations Specialized for TRA>

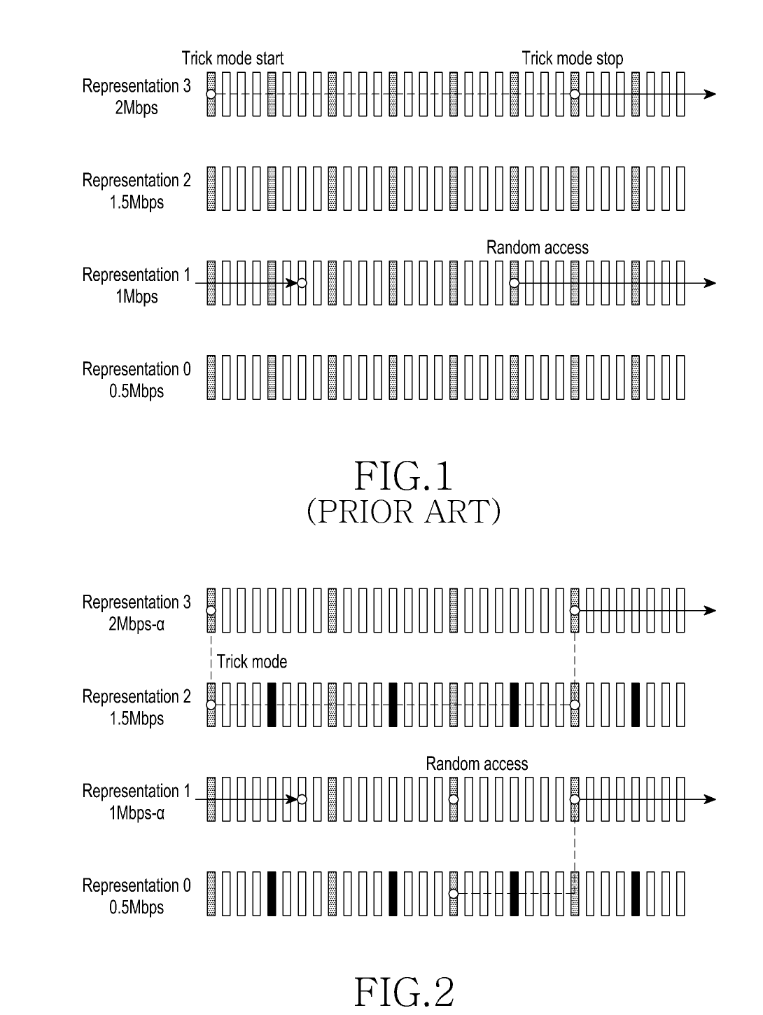

FIG. 2 illustrates a TRA operation according to an embodiment of the present invention.

Referring to FIG. 2, Representation 0 and Representation 2 are specialized for TRA. Black blocks represent added RAPs or added RAPs and IDR frames. Compared to FIG. 1, the number of RAPs or RAPs and IDR frames in Representation 1 and Representation 3 is decreased in FIG. 2. A client receiving Representation 3 may perform TRA in Representation 2 in FIG. 2. Because Representation 2 includes more RAPs and a lower bit rate than Representation 3, a TRA-incurred delay may be minimized for the client receiving Representation 3.

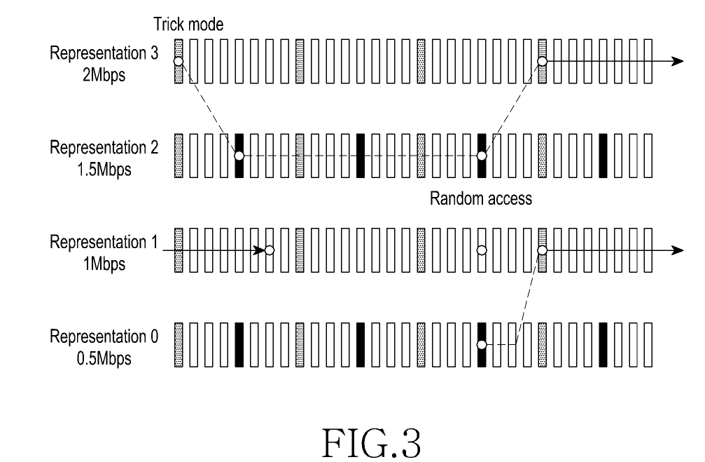

FIG. 3 illustrates a Representation including an index of reference to another Representation according to an embodiment of the present invention.

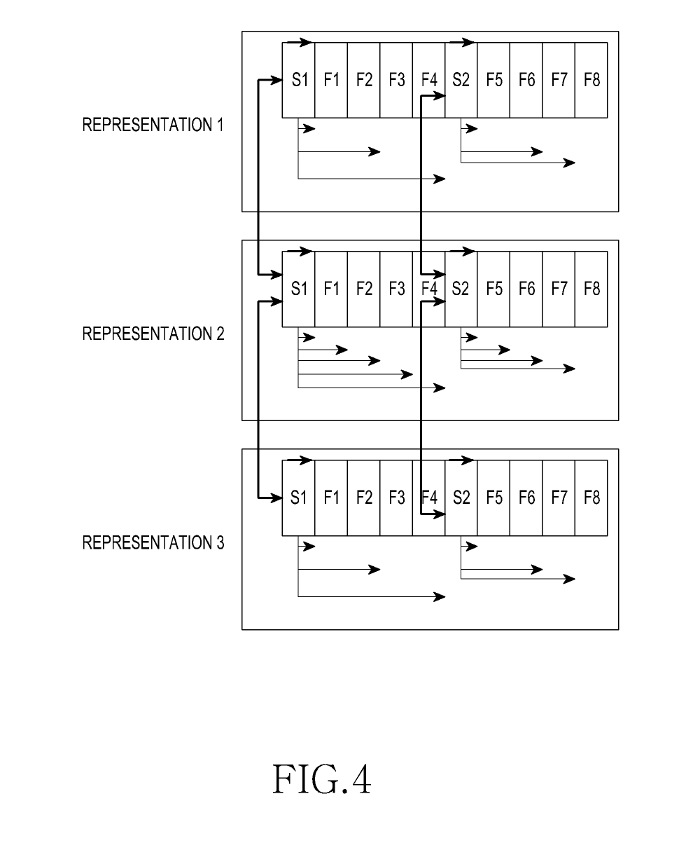

Referring to FIG. 3, reception of redundant data, as well as interaction, may be reduced through cross referencing between Representations. For this purpose, an sidx of one Representation contains point information about an sidx of another Representation, e.g., as illustrated in FIG. 4. The point information indicates a start point of an independently decodable frame such as a RAP or an I-Frame.

FIG. 4 illustrates an extended segment index (sidx) for cross referencing according to an embodiment of the present invention.

<MPD Extension>

To implement a method according to an embodiment of the present invention, a client should be able to identify Representations that are specialized for TRA. For this purpose, Table 2 illustrates a Media Presentation Description (MPD) according to an embodiment of the present invention.

TABLE 2

| | | | | This element contains a de- |
|---|---|---|---|---|
| Representation | E | 1..N | M | scription of a Representation. |
| bandwidth | A | | M | The minimum bandwidth of a |
| | | | | hypothetical constant bitrate |
| | | | | channel in bits per second |
| | | | | (bps) over which the |
| | | | | representation can be |
| | | | | delivered such that a client, |
| | | | | after buffering for exactly |
| | | | | minBufferTime can be |
| | | | | assured of having enough data |
| | | | | for continuous playout. |
| id | A | | M | Provides a unique identifier |
| | | | | for this Representation |
| | | | | within the Period. |
| width | A | | O | Specifies the horizontal |
| | | | | resolution of the video |
| | | | | media type in an alternative |
| | | | | Representation, counted in |
| | | | | pixels. |
| height | A | | O | Specifies the vertical |
| | | | | resolution of the video |
| | | | | media type in an alternative |
| | | | | Representation, counted in |
| | | | | pixels. |
| TRArepresentationFlag | A | | O | It indicates that the |
| | | | | Representations are used as |
| | | | | a TRA |

Referring to Table 2, for example, if TRArepresentationFlag is 0, this indicates that a Representation is a normal Representation, and if TRArepresentationFlag is 1, this indicates that the Representation includes a short RAP or I-Frame period, specialized for TRA. Thus, the client can identify Representations specialized for TRA using TRArepresentationFlag of the MPD. In this manner, the client may request an appropriate Representation.

<Delivery Format Extension: Segment Index Box for Multiple RAPs>

To support TRA modes, an sidx box of each segment is extended to include start points (byte offsets) and sizes of samples that provide a RAP function. An exemplary related algorithm is given as follows.

Syntax

```
aligned(8) class SegmentIndexBox extends FullBox(’sidx’, version, 0) {
    unsigned int(32) reference_track_ID;
    unsigned int(16) track_count;
    unsigned int(16) reference_count;
    for (i=1; i<= track_count; i++)
    {
        unsigned int(32) track_ID;
        if (version==0)
        {
            unsigned int(32) decoding_time;
        } else
        {
            unsigned int(64) decoding_time;
        }
    }
    for(i=1; i <= reference_count; i++)
    {
```

| | |
|---|---|
| bit (1) | reference_type; |
| unsigned int(31) | reference_offset; |
| unsigned int(32) | subsegment_duration; |

bit(1) contains_RAP;

| | | |
|---|---|---|
| unsigned int(31) | rap_count; | //added |

| for(j=1;j<=rap_count;j++) | | //added |
|---|---|---|
| { | | |
| unsigned(32) | RAP_delta_time; | //moved |
| unsigned(32) | Sample_start_offset; //added | |
| unsigned(32) | Sample_length; | //added |
| } | | |
| } | | |
| } | | |

Related variables of the algorithm above are defined as follows.

Sample_start_offset: a start offset from a reference offset of a sample including a RAP in bytes.

Sample_length: a byte length of one or more samples for the RAP.

<Segment Index Box for Cross Referencing>

Referring to FIG. 4, a Representation includes sidx offset information about another Representation to switch to. An exemplary related algorithm is given as follows:

Box Type: sidx

Container: None

Mandatory: No

Quantity: One per Segment Index Box

```
SYNTAX
aligned(8) class SegmentIndexBox extends FullBox(’sidx’, version, ,0) {
unsigned int(8) REF_Representation_count;
    for(i=1; i <= Representation_count; i++)
    {
        unsigned int(8) ref_Sidx_count;
        for(j=1; j <= ref_Sidx_count; j++)
        {
        unsigned int(31) Sidx_position
        }
    }
}
```

The following are the definitions of the variables in the algorithm above.

REF_Representation_count: the number of Representations to which reference indexes are preserved.

ref_Sidx_count: the number of reference indexes, i.e., the number of reference indexes that a media segment of a Representation has.

Sidx_position: the position of a reference index for content switching. The position may be replaced with an offset or byte range.

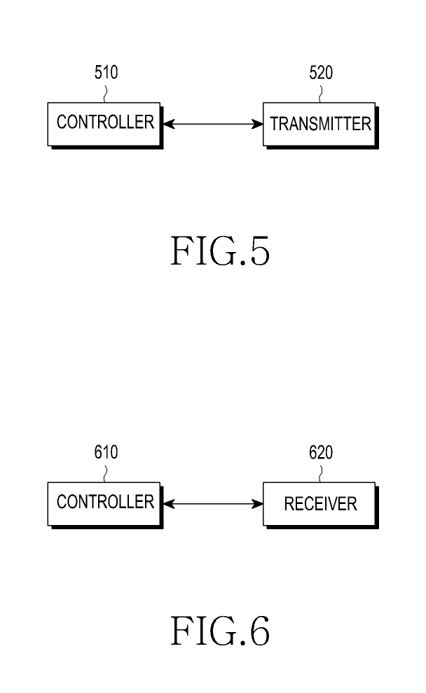

FIG. 5 is a block diagram illustrating an apparatus for providing a multimedia streaming service according to an embodiment of the present invention.

Referring to FIG. 5, the apparatus for providing a multimedia streaming service includes a controller 510 and a transmitter 520. As described above with reference to FIGS. 3 and 4, the controller 510 configures Representations in such a manner that the Representations may be cross-referenced. Notably, at least one of the Representations is specialized for TRA. The transmitter 520 transmits the configured multimedia stream.

FIG. 6 is a block diagram illustrating an apparatus for receiving a multimedia streaming service according to an embodiment of the present invention.

Referring to FIG. 6, the apparatus for receiving a multimedia streaming service includes a controller 610 and a receiver 620. The controller 610 provides the multimedia streaming service to a client using a Representation received from the apparatus for providing the multimedia streaming service through the receiver 620. The received Representation is configured so that cross referencing to other Representations is possible. The received Representation or at least one of the other Representations is specialized for TRA. The receiver 620 receives a multimedia stream.

While the present invention has been particularly shown and described with reference to certain embodiments thereof, it will be understood by those of ordinary skill in the art that various changes in form and details may be made therein without departing from the spirit and scope of the present invention as defined by the following claims.

What is claimed is:

1. A method for providing a multimedia streaming service using a plurality of multimedia streams, the method comprising:
configuring at least one of the plurality of multimedia streams to include reference information about at least one frame included in at least one other media stream from among the plurality of multimedia streams; and
transmitting the configured at least one of the plurality of multimedia streams.

2. The method of claim 1, wherein the reference information is included in at least one frame included in the configured at least one of the plurality of multimedia streams.

3. The method of claim 1, wherein the reference information is included in a header of at least one frame included in the configured at least one of the plurality of multimedia streams.

4. The method of claim 1, wherein the reference information includes information about a unit picture independently decodable in the frame.

5. The method of claim 1, wherein the reference information includes at least one of information about a number of the at least one other media stream, information about a number of pieces of reference information included in the at least one other media stream, and information about positions of the reference information included in the at least one other media stream.

6. A method for receiving a multimedia streaming service using a plurality of multimedia streams, the method comprising:
receiving a multimedia stream; and
reproducing the multimedia stream, wherein the received multimedia stream is configured to include reference information about at least one frame included in at least one other multimedia stream from among the plurality of multimedia streams.

7. The method of claim 6, wherein the reference information is included in at least one frame included in the received multimedia stream.

8. The method of claim 6, wherein the reference information is included in a header of at least one frame included in the received multimedia stream.

9. The method of claim 6, wherein the reference information includes information about a unit picture independently decodable in the frame.

10. The method of claim 6, wherein the reference information includes at least one of information about a number of the at least one other multimedia stream, information about a number of pieces of reference information included in the at least one other multimedia stream, and information about positions of the reference information included in the at least one other multimedia stream.

11. An apparatus for providing a multimedia streaming service using a plurality of multimedia streams, the apparatus comprising:
a controller for configuring at least one of the plurality of multimedia streams to include reference information about at least one frame included in at least one other multimedia stream from among the plurality of multimedia streams; and
a transmitter for transmitting the configured at least one multimedia stream.

12. The apparatus of claim 11, wherein the reference information is included in at least one frame included in the configured at least one multimedia stream.

13. The apparatus of claim 11, wherein the reference information is included in a header of at least one frame included in the configured at least one multimedia stream.

14. The apparatus of claim 11, wherein the reference information comprises information about a unit picture independently decodable in the frame.

15. The apparatus of claim 11, wherein the reference information comprises at least one of:
information about a number of the at least one other multimedia stream;
information about a number of pieces of reference information included in the at least one other multimedia stream; and
information about positions of the reference information included in the at least one other multimedia stream.

16. An apparatus for receiving a multimedia streaming service using a plurality of multimedia streams, the apparatus comprising:
a receiver for receiving a multimedia stream; and
a controller for reproducing the multimedia stream, wherein the received multimedia stream is configured to include reference information about at least one frame included in at least one other multimedia stream from among the plurality of multimedia streams.

17. The apparatus of claim 16, wherein the reference information is included in at least one frame included in the received multimedia stream.

18. The apparatus of claim 16, wherein the reference information is included in a header of at least one frame included in the received multimedia stream.

19. The apparatus of claim 16, wherein the reference information comprises information about a unit picture independently decodable in the frame.

20. The apparatus of claim 16, wherein the reference information comprises at least one of:
information about a number of the at least one other multimedia stream;
information about a number of pieces of reference information included in the at least one other multimedia stream; and
information about positions of the reference information included in the at least one other multimedia stream.
